(19) United States
(12) Patent Application Publication
(10) Pub. No.: US 2025/0048980 A1
(43) Pub. Date: Feb. 13, 2025

(54) Self-Watering Plant Growing System And Method Of Use

(71) Applicant: Joseph Augustin, Margate, FL (US)

(72) Inventor: Joseph Augustin, Margate, FL (US)

(21) Appl. No.: 18/231,318

(22) Filed: Aug. 8, 2023

(51) Int. Cl. A01G 27/04; A01G 9/02

(52) U.S. Cl. CPC A01G 27/04; A01G 9/02

(57) ABSTRACT

A self-watering plant growing system for self-watering of a plant includes a lower container and an upper container, each having an annular wall that extends from a bottom to an open top. The upper container, which can contain bedding and a plant, is stackable upon the lower container, which can contain water. A wicking element is positionable within the bedding in the upper container and is extendable through a set of slots, which is positioned in the bottom of the upper container, and into the water that is in the lower container. The wicking element transfers the water from the lower container into the bedding, by capillary action, to water the plant.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to planters and more particularly pertains to a new planter for self-watering of a plant. Self-watering of plants is desirable for busy or forgetful individuals and provides a consistent level of moisture for plants that can improve their growth and appearance.

### (2) Description of Related Art Including Information Disclosed Under 37 CFR 1.97 and 1.98

The prior art relates to planters for self-watering of plants by capillary action but which do not require stacking of one container containing a plant upon another container containing water.

### BRIEF SUMMARY OF THE INVENTION

An embodiment of the disclosure meets the needs presented above by generally comprising a lower container and an upper container, each having an annular wall that extends from a bottom to an open top. The upper container is configured to be stacked upon the lower container. The lower container is configured to contain water and the upper container is configured to contain bedding and a plant. A wicking element is positionable within the bedding in the upper container and is extendable through a set of slots, which is positioned in the bottom of the upper container, and into the water that is in the lower container. The wicking element is configured to transfer the water from the lower container into the bedding, by capillary action, to water the plant.

Another embodiment of the disclosure includes method of growing a plant, which comprises providing the self-watering plant growing system, according to the disclosure above. Steps of the method include adding water to the lower container, positioning the wicking element in the upper container, extending the wicking element through the set of slots, adding a plant and bedding to the upper container, stacking the upper container upon the lower container, and transferring of the water by capillary action through the wicking element from the lower container into the bedding to water the plant.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a self-watering plant growing system according to an embodiment of the disclosure in use.

FIG. 2 is a side view of an embodiment of the disclosure in use.

FIG. 3 is a cross-sectional view of an embodiment of the disclosure in use.

FIG. 4 is an exploded view of an embodiment of the disclosure.

FIG. 5 is a top view of an upper container of embodiment of the disclosure.

FIG. 6 is a bottom view of an upper container of an embodiment of the disclosure.

FIG. 7 is a flow diagram for a method utilizing an embodiment of the disclosure.

### DETAILED DESCRIPTION OF THE INVENTION

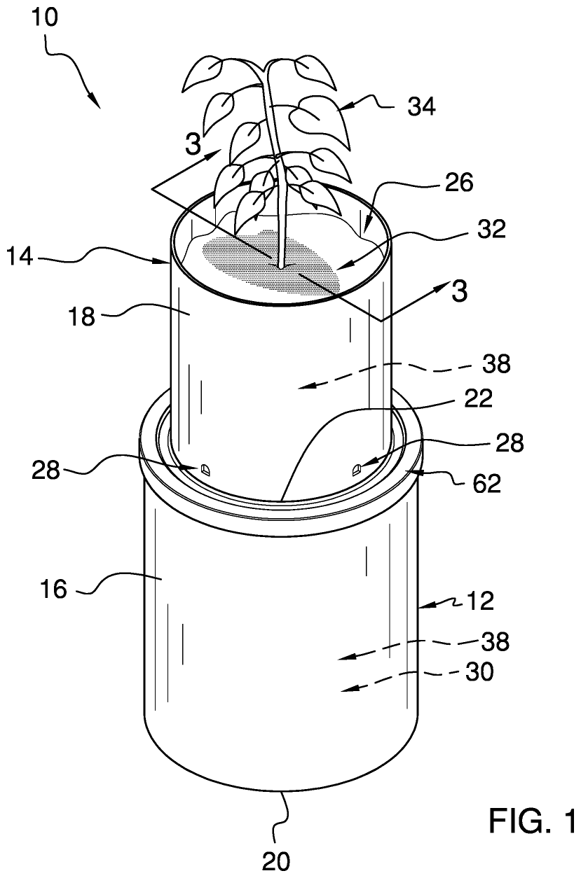

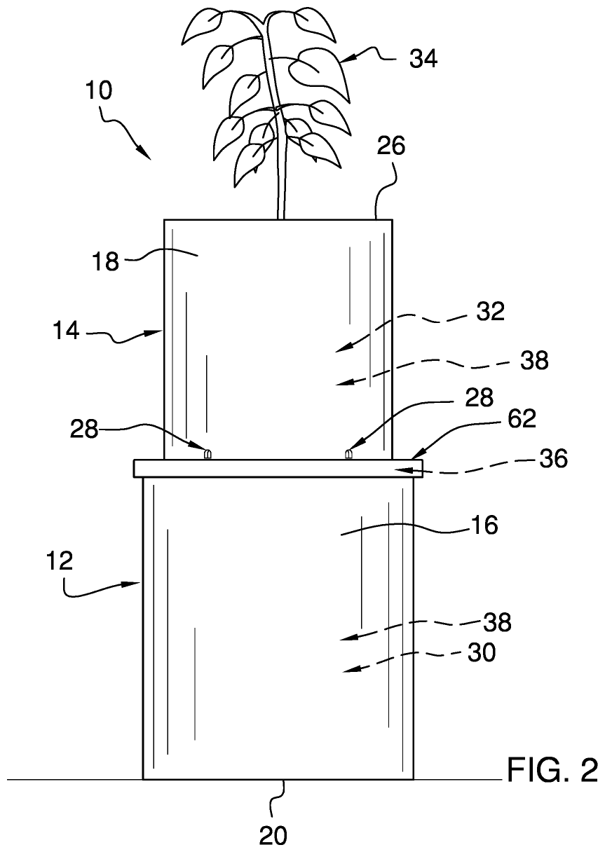

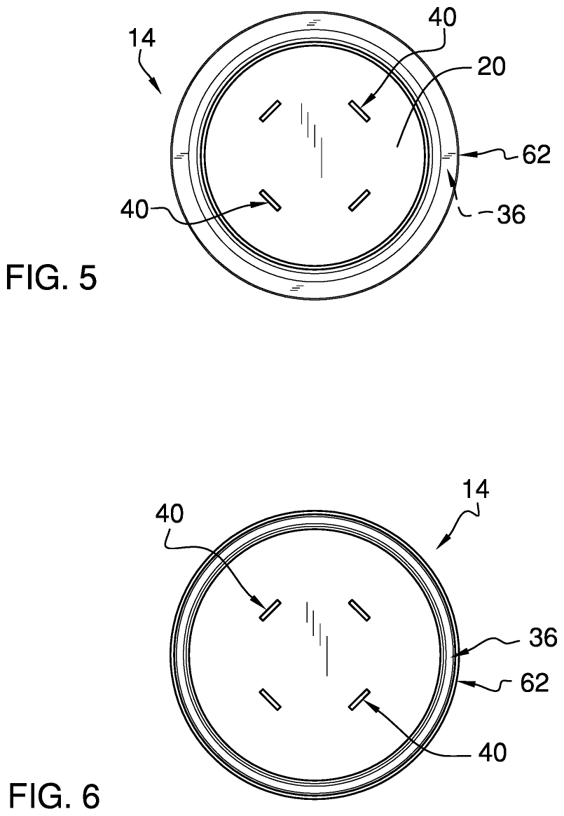

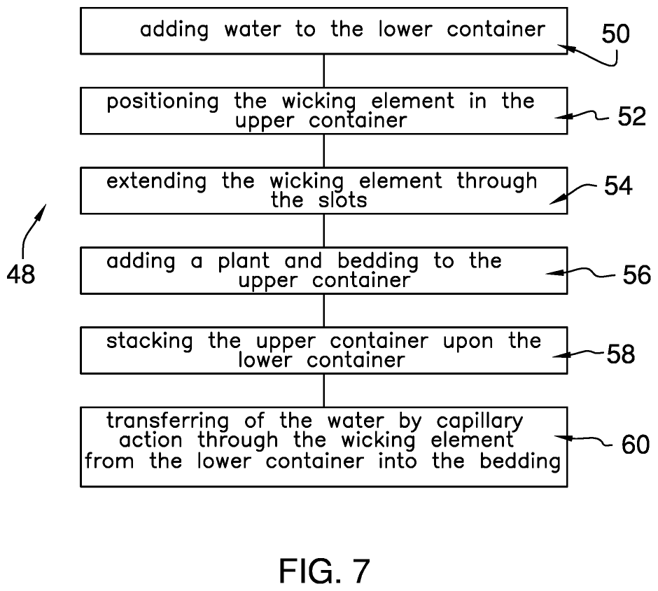

With reference now to the drawings, and in particular to FIGS. 1 through 7 thereof, a new planter embodying the principles and concepts of an embodiment of the disclosure and generally designated by the reference numeral 10 will be described.

As best illustrated in FIGS. 1 through 7, the self-watering plant growing system 10 generally comprises a lower container 12 and an upper container 14, each having an annular wall (16 and 18, respectively) that extends from a bottom (20 and 22, respectively) to an open top (24 and 26, respectively). The lower container 12 and the upper container 14 comprise metal, ceramic, wood, plastic, or the like, and may be cylindrical, as is shown in FIGS. 1-4, or alternatively shaped, such as, but not limited to, cuboid, prismatic, or the like. The lower container 12 and the upper container 14 need not necessarily have the same shape but must be shaped and sized so as to be stackable. A plurality of holes 28 is positioned in the upper container 14 proximate to the bottom 22 of the upper container 14 and is configured to vent the upper container 14.

The lower container 12 is configured to contain water 30 and the upper container 14 is configured to contain bedding 32 and a plant 34. Water 30 in the context of this disclosure should be interpreted to mean water 30 and solutions of water 30, such as fertilizer solutions, nutrient solutions, antibiotic solutions, or the like, or combinations thereof. Bedding 32, in the context of this disclosure should be interpreted to mean soil, peat moss, or the like, or mixtures thereof.

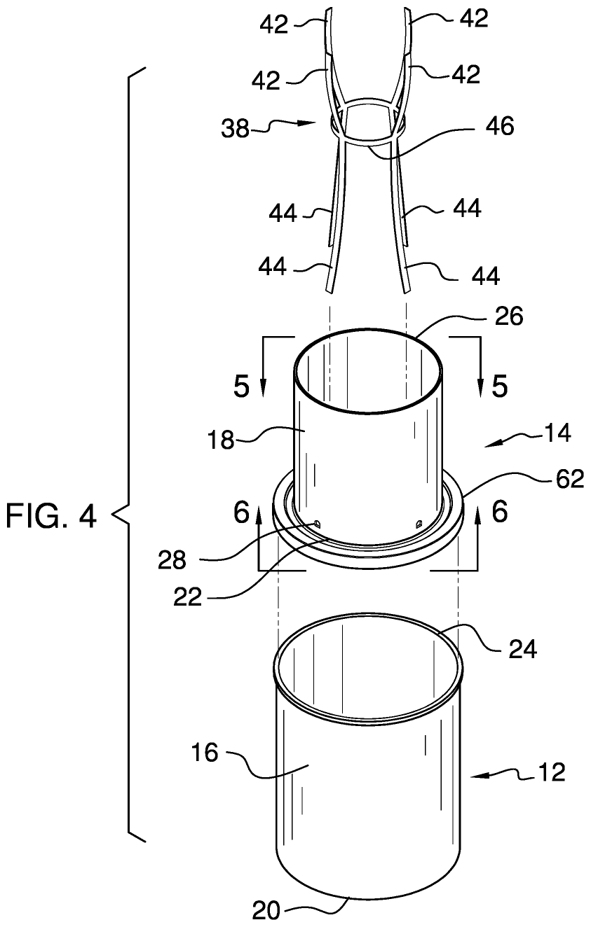

The upper container 14 is configured to be stacked upon the lower container 12. As is shown in FIG. 4, the bottom 22 of the upper container 14 is circumferentially smaller than the open top 24 of the lower container 12. A rim 62 is attached to and extends axially from and circumferentially around the bottom 22 of the upper container 14 to define a channel 36. The channel 36 is sized and shaped complementarily to the open top 24 of the lower container 12 so that the annular wall 16 of the lower container 12 is insertable into the channel 36 to stack the upper container 14 upon the lower container 12. Other means of rendering the upper container 14 stackable upon the lower container 12 are anticipated by the present invention. As one example, the bottom 22 of the upper container 14 may be circumferentially larger than the open top 24 of the lower container 12, thereby allowing the upper container 14 to rest upon the lower container 12.

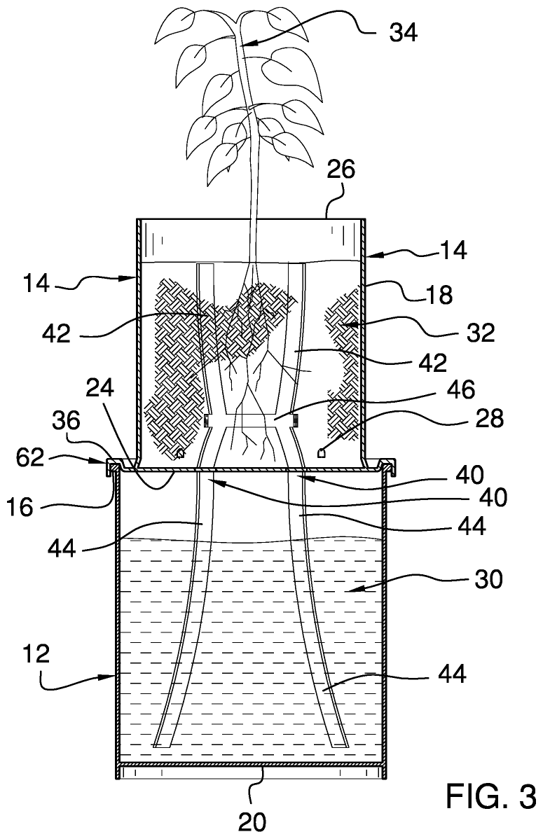

A wicking element 38 is positionable within the bedding 32 in the upper container 14 and is extendable through a set of slots 40, which is positioned in the bottom 22 of the upper container 14, and into the water 30 that is in the lower container 12. The wicking element 38 is configured to transfer the water 30 from the lower container 12 into the bedding 32, by capillary action, to water the plant 34, as is depicted in FIG. 3. The wicking element 38 may comprise microfiber cloth, as is shown in FIGS. 3 and 4, or other materials capable of capillary action, such as, but not limited to, strands of polymeric hairs, sets of polymeric tubes having small internal diameters, or the like.

As is shown in FIGS. 3, the wicking element 38 comprises a plurality of upper strips 42 and a plurality of lower strips 44, which are attached to and which extend upwardly and downwardly, respectively, from a ring 46 that is positioned in the upper container 14. The plurality of lower strips 44 extends from the ring 46 through the set of slots 40 into the lower container 12. The plurality of upper strips 42 comprises from two to six upper strips 42 and the plurality of lower strips 44 comprises from two to six lower strips 44. The plurality of upper strips 42 may comprise four upper strips 42 and the plurality of lower strips 44 may comprise four lower strips 44, as is shown in FIG. 4.

In use, the self-watering plant 34 growing system enables a method of growing a plant 48, which comprises providing the self-watering plant growing system 10, according to the specification above. A first step 50 of the method 48 is adding water 30 to the lower container 12. A second step 52 of the method 48 is positioning the wicking element 38 in the upper container 14. A third step 54 of the method 48 is extending the wicking element 38 through the set of slots 40. A fourth step 56 of the method 48 is adding a plant 34 and bedding 32 to the upper container 14. A fifth step 58 of the method 48 is stacking the upper container 14 upon the lower container 12 so that the wicking element 38 extends into the water 30 in the lower container 12. A sixth step 60 of the method 48 is transferring of the water 30 by capillary action through the wicking element 38 from the lower container 12 into the bedding 32 to water the plant 34.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A self-watering plant growing system comprising:
a lower container and an upper container each having an annular wall extending from a bottom to an open top, the upper container being configured to be stacked upon the lower container, the lower container being configured to contain water, and the upper container being configured to contain bedding and a plant; and
a wicking element positionable within the bedding in the upper container and extendable through a set of slots positioned in the bottom of the upper container into the water in the lower container, wherein the wicking element is configured to transfer the water from the lower container into the bedding by capillary action to water the plant.

2. The self-watering plant growing system of claim 1, wherein the lower container and the upper container comprise metal, ceramic, wood, or plastic.

3. The self-watering plant growing system of claim 1, wherein the lower container and the upper container are cylindrical.

4. The self-watering plant growing system of claim 1, further including a plurality of holes positioned in the upper container proximate to the bottom of the upper container, wherein the plurality of holes is configured to vent the upper container.

5. The self-watering plant growing system of claim 1, wherein the wicking element comprises microfiber cloth.

6. The self-watering plant growing system of claim 1, wherein the wicking element comprises:
a ring positioned in the upper container;
a plurality of upper strips attached to and extending upwardly from the ring; and
a plurality of lower strips attached to and extending downwardly from the ring through the set of slots into the lower container.

7. The self-watering plant growing system of claim 6, wherein:
the plurality of upper strips comprises from two to six upper strips; and
the plurality of lower strips comprises from two to six lower strips.

8. The self-watering plant growing system of claim 7, wherein:
the plurality of upper strips comprises four upper strips; and
the plurality of lower strips comprises four lower strips.

9. The self-watering plant growing system of claim 1, further including:
the bottom of the upper container being circumferentially smaller than the open top of the lower container; and
a rim attached to and extending axially from and circumferentially around the bottom of the upper container and defining a channel, the channel being sized and shaped complementarily to the open top of the lower container, such that the annular wall of the lower container is insertable into the channel to stack the upper container upon the lower container.

10. A self-watering plant growing system comprising:
a lower container and an upper container each having an annular wall extending from a bottom to an open top, the upper container being configured to be stacked upon the lower container, the lower container being configured to contain water, and the upper container being configured to contain bedding and a plant, the bottom of the upper container being circumferentially smaller than the open top of the lower container, the lower container and the upper container comprising metal, ceramic, wood, or plastic, the lower container and the upper container being cylindrical;
a plurality of holes positioned in the upper container proximate to the bottom of the upper container, wherein the plurality of holes is configured to vent the upper container;
a wicking element positionable within the bedding in the upper container and extendable through a set of slots positioned in the bottom of the upper container into the water in the lower container, wherein the wicking element is configured to transfer the water from the lower container into the bedding by capillary action to water the plant, the wicking element comprising microfiber cloth, the wicking element comprising:
a ring positioned in the upper container;
a plurality of upper strips attached to and extending upwardly from the ring, the plurality of upper strips comprising from two to six upper strips, the plurality of upper strips comprising four upper strips; and
a plurality of lower strips attached to and extending downwardly from the ring through the set of slots into the lower container, the plurality of lower strips comprising from two to six lower strips, the plurality of lower strips comprising four lower strips; and
a rim attached to and extending axially from and circumferentially around the bottom of the upper container and defining a channel, the channel being sized and shaped complementarily to the open top of the lower container, such that the annular wall of the lower container is insertable into the channel to stack the upper container upon the lower container.

11. A method of growing a plant comprising providing the self-watering plant growing system of claim 1, and:
adding water to the lower container;
positioning the wicking element in the upper container;
extending the wicking element through the set of slots;
adding a plant and bedding to the upper container;
stacking the upper container upon the lower container, such that the wicking element extends into the water in the lower container; and
transferring of the water by capillary action through the wicking element from the lower container into the bedding to water the plant.
